(19) United States
(12) Patent Application Publication
(10) Pub. No.: US 2025/0322095 A1
(43) Pub. Date: Oct. 16, 2025

(54) SECURE REPORTING OPERATIONS WITH MULTIPLE DATA VAULTS

(71) Applicant: SKYFLOW INC, Los Altos, CA (US)

(72) Inventors: Manish Ahluwalia, Peoria, AZ (US); Amruta Moktali, San Francisco, CA (US); Roshmik Saha, Palo Alto, CA (US); Birudavolu Pradeep, Palo Alto, CA (US)

(21) Appl. No.: 18/632,066

(22) Filed: Apr. 10, 2024

(51) Int. Cl. G06F 21/62; G06F 21/60; H04L 9/08

(52) U.S. Cl. CPC G06F 21/6227; G06F 21/602; H04L 9/0861; H04L 9/0894

(57) ABSTRACT

Secure reporting operations are described that are suitable with multiple data vaults. An escrow service facilitates such reporting operation with a requester data interface to receive a request to perform an operation and to receive requester values from a requester data vault. The operation request identifies the operation and fields of the requester data vault with which to perform the identified operation. A data interface receives transformed values from a partner data vault, the values being transformed using a key. An operation engine establishes the key for the transformation of values from the partner data vault, to perform an operation on the transformed values and the requester values, to compile results of the operation as a report, and to configure the report using the requester values, wherein the requester interface is further to send the report to the requester.

### FIELD

Embodiments of the invention relate to the field of data security; and more specifically, to an escrow service to perform operations on data from multiple data vaults.

### BACKGROUND

In recent decades, businesses have significantly increased the amount of sensitive data they collect in order to create personalized customer experiences and unlock new growth opportunities. This sensitive data is kept secure using encryption, permissions, limited access, and other tools. Regulatory agencies have also intervened to restrict the release of private and personal information of customers, suppliers, subscribers, and others. Businesses are sometimes required to take specific measures with particular types of information, including encryption PII (Personally Identifiable Information) and hosting the sensitive data in particular locations

The value of this sensitive data increases as it is combined with the data other companies have collected about their customers; particularly when common customers or customers with similar traits are identified. This allows for various benefits in providing still better service to customers, e.g., by targeting particular needs or desires of particular customers and in Analytics to better understand customer groups and trends. At the same time, contractual agreements and government regulations make it hard for data owners to share their data with others.

### BRIEF DESCRIPTION OF THE DRAWING FIGURES

The invention may best be understood by referring to the following description and accompanying drawings that are used to illustrate embodiments of the invention. In the drawings:

FIG. 1 is a block diagram of an escrow service coupled to multiple data vaults to perform data operations according to embodiments of the invention;

FIG. 2 is a block diagram of an escrow service coupled to secure data vaults according to embodiments of the invention;

FIG. 3 is a is a functional diagram of the operation of the apparatus of FIG. 2;

FIG. 4 is an example block diagram of data vaults with multiple account access suitable for use with the escrow service according to embodiments of the invention;

FIG. 5 is a diagram of a GUI (Graphical User Interface) for an example schema for a customer identity data vault according to embodiments of the invention;

FIG. 6 is a diagram of a GUI (Graphical User Interface) for an example schema for a payments data vault according to embodiments of the invention;

FIG. 7 is a process flow diagram of performing an operation on data vaults and reporting the result to a requester according to embodiments of the invention; and

FIG. 8 is a block diagram of a computer system according to embodiments of the invention.

### DETAILED DESCRIPTION

Data security systems seek to find some compromise between access and security. This means that only the authorized systems, processes, and personnel are allowed to perform any queries or other operations on the data under the right restrictions. Typically, this will include restricting access to their data to other entities outside the company. Such a data security system, that protects data while allowing access to the right parties, is sometimes referred to as a data vault.

With a data vault, it may be difficult to share information with a business or policy partner even when a business or other kind of entity has determined to share some part of that information with another. In an example, a requester has a secure data vault with PII for a list of patrons. A first partner has its own secure data vault with PII for its list of patrons. The first partner cannot share the PII with the requester but has determined to share some information.

In order to maintain the security, privacy, or both of the PII, a system is described here (the “escrow service”) in which the two (or more) partners put their data into their own data vaults and prevent the other partners from accessing their respective data vault, thereby securing their own data. The data vaults and the escrow service may work together to allow the secure execution of a desired combined query, e.g., finding matching users, without leaking any data outside of the vaults and the escrow service. Specifically, each vault can ensure that it does not expose any PII outside itself, not even to the escrow service or the other vaults participating in the escrow; and it can do so in a way that, e.g., a matching set of users can be computed by the escrow service.

In some embodiments this is done by the vault canonicalizing and then transforming the PII to be matched with e.g., a keyed one-way transformation. The canonicalized, transformed values are exposed to the escrow service. In this context, the canonicalized data follows a consistent data model between the various vaults that allows the escrow service to perform the requested operations. This may be illustrated using an example. The principles of the example may be applied to other fields and other values. In this example, the requested operation is a JOIN operation on the values of the email field or at least some of the records. In this example, one data vault has email in the form of “FIRSTNAME@email.com.” Another data vault has email in the form of “firstname+folder1@email.com.” The canonical form is “firstname@domain.tld.” To canonicalize the email formats, the escrow service may give instructions to the data vaults to: (a) convert to lowercase, (b) remove the material after “+”, and then (c) perform a one-way keyed transformation using the established encryption key.

The key for the one-way transformation may be established in an escrow session by the service and shared between the different participating partners. The escrow service can then perform a match or other operation on the PII from the vaults of the participating partners without needing access to the PII itself. Moreover, the key and the transformed PII never needs to leave the escrow service. Thus, the matching, or another computation, can be performed without PII exposure outside of the vaults. In this example, the escrow service can then find patrons that are common to both partners. The escrow service can also perform any of a number of different operations, depending on the intentions of the two or more partners.

The escrow service can establish a session in a variety of different ways. For example, the escrow service and an administrator can start an escrow session and invite various partners that own data vaults to join the session through respective data vault interfaces. Any of a variety of different communication protocols and data formats may be used, e.g., HTTPS (Hyper-Text Transfer Protocol Secure), SSH (Secure Shell) tunneling, IPsec VPN (Internet Protocol Security Virtual Private Network), and any other that provides a suitable secure connection with a suitable from of authentication of each side to the other. Each data vault, upon entering the session, may be securely given access to a session key which is used to perform one-way transformations. This key is protected by each data vault and is not exposed. For additional security, the key may be restricted for use in transforming values for the datasets that are conveyed to the escrow service and for no other purpose. There is no need for the partner that owns the vault to have or use the key for any purpose of that partner. The key may be made to expire after completion of the requested operation or based on another event.

A suitable key may be selected or generated by one party of the parties to the session, e.g., a vault or the escrow service and then sharing that key with the other parties to the session. In some embodiments, the key is generated externally, e.g., using a KMS (Key Management System) or by an administrator. In some embodiments, a symmetric key is used to do an HMAC (Hash-based Message Authentication Code) or GMAC (Galois Message Authentication Code), to allow for authentication and secure communication between the parties. A variety of different suitable keys and encryption protocols allow for a keyed one-way transformation.

In some embodiments, the escrow service operation may be implemented as a clean room or data clean room in which information loss is bounded. The clean room allows various parties to mix data securely. Bounds on the exposure of information to other parties participating in the clean room is guaranteed by an advance agreement for any session. The clean-room may be implemented as an isolated portion of compute infrastructure that handles data from the various parties and processes the data to find the required commonalities or other attributes between the various datasets. This puts the burden of maintaining compliance with data security and data privacy on the operator of the clean room and away from the owner of each data vault. The clean room operator may be a third party or it may be one of the parties subject to the sharing restrictions.

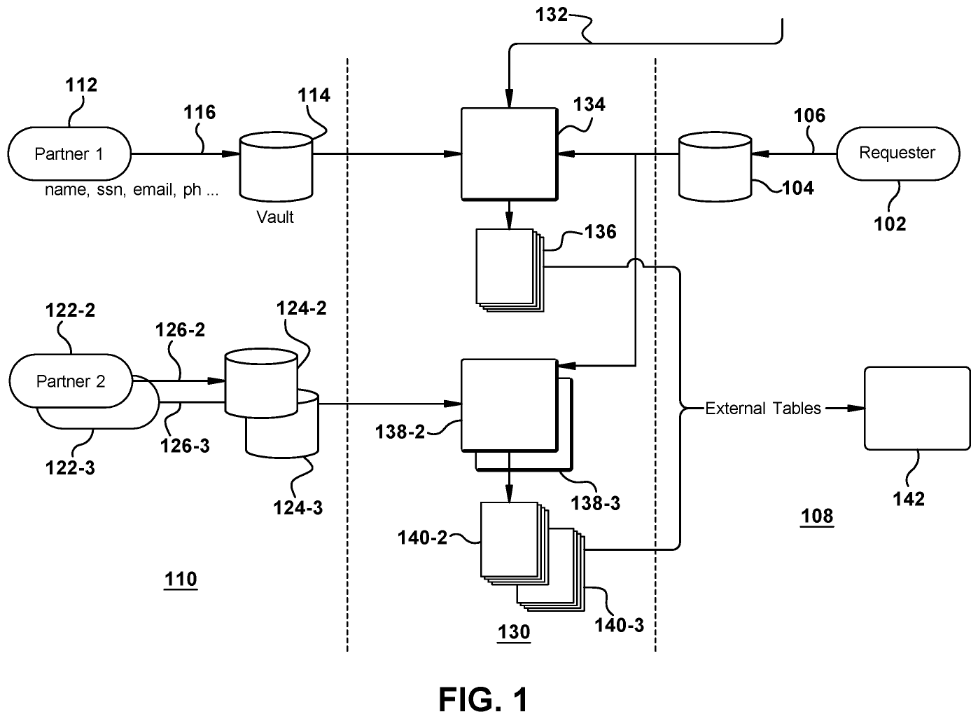

FIG. 1 shows a requester 102 with a requester data vault 104 on a requester-owned side 108. The requester-owned side conceptually represents requester facilities, but the facilities may be in distributed locations or virtualized. The requester data vault 104 is used to store information that is important to the operation of the business of the requester and that is important to keep secure from unauthorized persons at the requester and outside of the requester's business. As shown, data from the requester 102 is ingested through a data link 106 into the requester data vault 104.

On a partner-owned side 110 a first partner 112 is coupled to a first partner data vault 114. The partner-owned side conceptually represents partner facilities, but the facilities may be in distributed locations or virtualized. The requester may operate all or part of the partner facilities or vice-versa. The first partner data vault 114 is used to store information that is important to the operation of the business of the first partner and that is important to keep secure from unauthorized persons at the first partner and outside of the first partner. Data from the first partner 112 is ingested through a data link 116 into the first partner data vault 114. Additional partners 122-2, 122-3 on the partner side 110 are also coupled to respective data vaults 124-2, 124-3 through respective data links 126-2, 126-3. While three partners are shown, there may be one partner or many more partners.

An escrow service 130 is positioned conceptually between the requester-owned side 108 and the partner-owned side 110. The escrow service may be physically located in any location and may be owned or operated in whole or part by the requester or one or more partners. The position of the escrow service shows that the escrow service has connections to the requester data vault 104 and one or more partner data vaults 114, 124-2, 124-3. The escrow service is not a data escrow or a software escrow in a traditional sense. The escrow service may be referred to as a clean room, an interface service, a functional data operation server, or by other terms and expressions. It will be referred to as an escrow service herein because, at least in some embodiments, it receives data from different data vaults but only releases data to data vault owners upon the satisfaction of particular terms and conditions which have been agreed to in advance. The released data may not be the actual data but is more likely information about the data, such as that data in a partner's data vault had the same name, address, or account number as data in the requester data vault.

The escrow service includes a database engine 134, also referred to as an operation engine, coupled to the requester data vault 104 and to the partner data vault 114. The database engine performs operations on data received from the data vaults 104, 114 and provides the results to a data store 136. Additional database engines 138-2, 138-3 are coupled to the other partner data vaults 124-2, 124-3 to generate results that are provided to respective data stores 140-2, 140-3. The data stores are coupled to external tables 142 to provide the results to the requester. The external tables may be hosted with the requester, as shown, with the escrow service 130 or in any other suitable location. While multiple database engines, data stores, data vaults, and connections are shown, the physical configuration and locations of data and computing assets may be adapted to suit different business and security needs. In some implementations, all of the components are hosted on virtual resources or in cloud computing systems.

The requester and the partner each have their own data vaults in the sense that the data stored in the respective data vault is supplied by and used by the requester and the partner, respectively. A third party may own or operate a data vault or both on behalf of the requester or the partner. The data may belong, at least in part, to customers and suppliers of the requester and the partner. Each entity has access only to its own data vault and can control the terms, conditions, and restrictions on any possible access by others. Access by others may be made conditional and revocable.

In one example, the requester has been provided with authorization from the partner to invoke a join query on the partner data vault. The requester, partner, and escrow service may use a remote connection by first establishing one or more encryption keys using any one of a variety of different methods.

The escrow service receives a join command 132, e.g., a SQL (Structured Query Language) INNER JOIN command. In response to this command the escrow service 130 computes the intersection between the requester data vault 104 and the partner data vault 114 in a database engine 134 and exports the results to a data store 136. The database engine has access to the requester data vault 104 and the partner data vault 114 in accordance with a set of rules established in advance with the agreement of the requester and the partner to protect any security needs and to comply with any regulatory demands.

In one example, the database engine 134 performs encrypted analytics, e.g., invisible joins, on canonicalized PII. In one example an invisible join uses a column in a WHERE clause of a database but not the column in the SELECT clause. As a result, plaintext PII never leaves the partner data vault 114 and is not available to the database engine. The PII fingerprints that are used by the database engine 134 are not exposed outside of the escrow service 130. In one example, the join query only allows configured projections. In some embodiments, the join reveals only the set of the requester's patrons that overlap with the partner's patrons, e.g., requester customers that are also partner's customers.

The data store 136 may be mounted as a part of an external table 142 with the requester that is available to the requester for its own business purposes. The data store 136 and the external table 142 do not contain any PII from the partner data vault, in plaintext but in a transformed form that may be used to perform the escrow operations. In some embodiments, a canonicalized, keyed one-way transformation is used. The external table 142 shows the intersection of users. In some circumstances the partner may choose to make more information from the partner data vault 104 or other partner data (not shown) available to the requester in the external table 142 or in another way.

The escrow service provides the results of a requested operation to the external tables 142 in the form of the requester's information. The requester is the one requesting the escrow service. Using the form of the requester's information protects the requester's and the first partner's information. Returning to an example of PII, the requester may have a record for a “William” and the first partner may have a record for the same person using the name “Bill.” By presenting the match to Bill as a tag on the requester's information, the use of the name “Bill” is not shared with the requester. As another example, the requester may have the last four digits of a credit card number, but the first partner has the complete credit card number. By presenting the match as a tag on the requester's information, the rest of the credit card number is not revealed.

As described herein, the escrow service uses transformed information from each partner's secure data vault to perform the operations, e.g., an HMAC keyed one-way transformation using a negotiated encryption key. In this way, the data in each secure data vault stays secure and neither party has access to the encrypted data in the other partner's secure data vault. The escrow service is nor provided with access to the most sensitive data in clear text or in the form in which it is encrypted in the data vault. The escrow service has only the data in the transformed form. The transformation is selected to allow the requested operations. The transformed form of the data is needed only as long as it takes to perform the operation at the escrow service and provide the result. After that the data may be cleared or erased from temporary buffers and the access to each secure data vault may be disconnected.

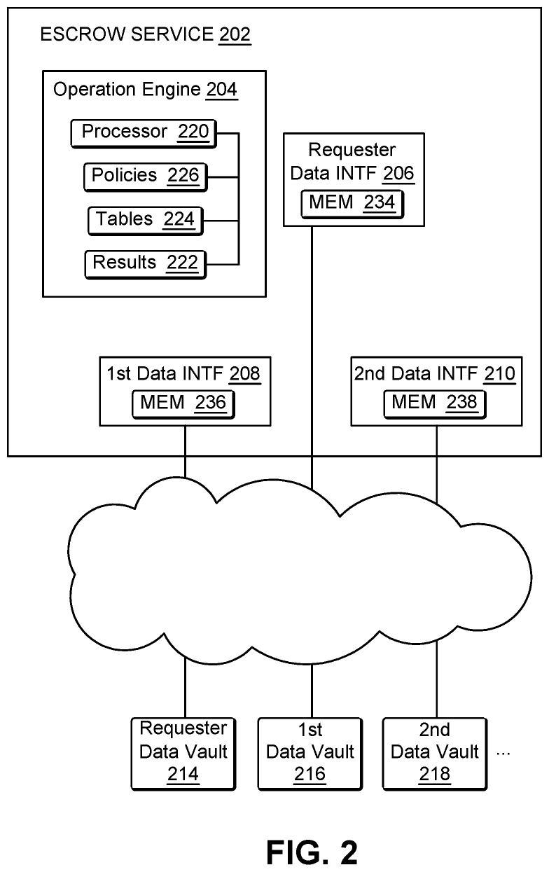

FIG. 2 is a block diagram of an escrow service coupled to data vaults. The escrow service 202 has an operation engine 204, also referred to as a database engine, coupled to a requester data interface 206, a first data interface 208, and a second data interface 210. The requester data interface 206 is coupled to a requester data vault 214 through a cloud connection in this example. The requester data interface 206 may be coupled to the requester data vault 214 directly, through an intranet, a local area network, a wide area network, or any other suitable data communication means. The requester data interface 206 receives transformed values from the requester data vault 214 and stores the transformed values in a first local memory 234. The requester data interface 206 allows a user to send a request to the escrow service 202. The requester data interface 206 receives the request and sends any suitable replies or reports to the requester data vault 214. The particular communications interface between the requester data interface 206 and the requester data vault 214 may be adapted to suit the nature of the connection between the two devices. A browser or app interface may be used at the requester data vault. APIs or other suitable command, query, and reply techniques may be used.

The operation engine 204 includes a processor 220 to perform operations requested by the requester data vault and to control the operation of the escrow service 202. The processor is coupled to a policies store 226 that contains policies for the requester data vault 214 and for first and second data vaults 216, 218. Upon receiving a request through the requester data interface 206, the processor compares the request to the policies in the policy store to determine whether the request is permitted by the policies. The processor 220 is coupled to a results memory 222 and a reports memory 224. The processor stores the results of the requested operations in the results memory and compiles the stored results as reports in the reports memory 224. The processor configures the reports for the requester data vault 214 to be sent through the requester data interface 206.

The first data interface 206 is coupled to a first data vault 216. The first data interface 206 is connected to the first data vault 216 through e.g., a cloud connection. The first data vault 216 may be local on an intranet, remote through a cloud connection as shown or hosted by a third party and accessible through a local area network, wide area network, or any other suitable data communication means. The governance level, described above may be provided at the first data interface or with the first data vault. The first data interface receives transformed values from the first data vault and stores the transformed values in a first local memory 236. The values may be limited to those necessary to perform the operations by the operation engine. Similarly, the second data interface 208 is coupled to a second data vault 218 in any of the ways mentioned above to receive transformed values from the second data vault 218 and store the values in a second local memory 238.

While first and second data interface are shown, a single data interface may be used to access both the first and the second data vaults. There may be additional data vaults and additional data interfaces. In addition, a single data vault may be divided into partitions. The partitions may be accessed by the same or different data interfaces. The partitions may be accessed using different permissions, different protocols, or different physical interfaces. The values in the first local memory 236 and the second local memory 238 may be accessed by the operation engine to perform the requested operations and store the results in the results memory 222. The received transformed values may also be encrypted and may also be transformed into a format to match a canonical data model used by the operations engine to perform operations on the received values.

The connections between the data vaults and the respective data interfaces may be physically secured or secured through a session, a tunnel, or other means. In some embodiments, the escrow service and an administrator can start a secure session and invite various partners that own data vaults to join the session through respective data vault interfaces. The various partners may all be invited to a single session. Alternatively, there may be multiple sessions involving the same parties at any given time. Different sessions may be used to support different data sharing, authentication, and governance needs, inter alia. In some embodiments, there may be multiple vaults in the same session. Each vault may negotiate a different key between the vault and the escrow service. Once the data from each vault has been pulled into the escrow service's memory, the escrow service may perform different operations, e.g., filter, join, etc. on the data in the escrow service's memory. As an example, this may be a JOIN across multiple tables.

Each data vault, upon entering the session, may be securely given access to a session key which is used to perform one-way transformations. This key may be protected by the data vault that secured it. The key is not shared with other data vaults and is only used to convey transformed datasets to the escrow service. In some embodiments, the data vaults are secure and some of the fields contain PII which is stored in an encrypted form in accordance with a PDP as described above. Sending the key and receiving transformed values may be performed within the escrow session.

In some embodiments, the requester data vault is associated with and has access to the first data vault but is not associated with and does not have access to the second data vault but this is not required. In some embodiments, the requester data vault is not associated with either of the data vaults. One or both of the data vaults may have complete or partial information for each record. There may be only a few fields for each record in a data vault and access to particular fields of a data vault may be restricted based on governance layers and policies. Using the data interfaces, the operation engine receives data from the respective data vault to perform operations requested by the requester data vault. The data is first transformed, e.g., using a one-way transformation with a session key, by the respective vault into a consistent data format for use by the escrow service. The data interfaces temporarily store the transformed data in memory 236, 238 where it is accessible to the operation engine 204 of the data interface 210.

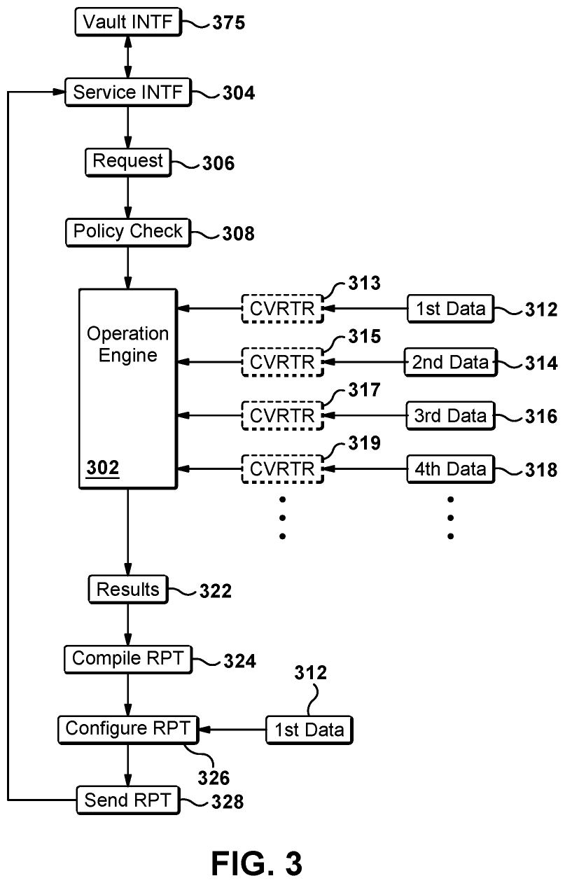

FIG. 3 is a functional diagram of the operation of the apparatus of FIG. 2. The functional diagram has an operation engine 302 or database engine at the center that performs a requested operation on requested data. A service interface 304 receives a request 306 from an external agent 375 which has been denoted as a vault interface, for example the requester data interface 206 of FIG. 2. The request 306 is passed through a policy check 308 to determine whether the requester, for example, the vault interface is permitted to make the request. If the request 306 passes the check 308, then it is received at an operation engine to perform the requested operations.

The operation engine 302 has access to a first data vault 312, a second data vault 314, a third data vault 316, a fourth data vault 318 and other data vaults as may be needed to perform the operations. The first data vault 312 may provide data directly to the operation engine 302 or the values may first be transformed by a first data converter 313 before it is used by the operation engine. Similarly, there may be a converter 315, 317, 319 between the operation engine and each respective data vault 312, 314, 316, 318 to transform the received values as may be needed. Alternatively, a single converter may convert the values of more than one data vault or one or more converters may be a part of the operation engine. The converters may function to decrypt the data in a data vault, but security is enhanced when the operation engine operates on data that is transformed and the operation engine never sees the data in plain text. In embodiments, the converters serve to convert the encrypted data in a respective vault to a different transformed form so that transformed data from different vaults may be compared.

The service interface 304 is a part of the escrow service and it communicates with an external agent 375, referred to as the vault interface, which represents an interface that may be under the control or operation of a variety of different entities. The vault interface may be a console, an app, a server, or other communications device. In some examples, the vault interface operates the first data vault 312 or a few data vaults but has no access to any of the other data vaults 314, 316, 318. In accordance with an agreement between the operator of the vault interface and the operator of another data vault, a policy has been generated for the policy check 308 that allows the operator of the vault interface to obtain some insight into the data in the other data vault. The operation engine 302 may be owned and operated by any entity, but it does not have access to any of the data vaults except to perform operations that are consistent with the policy checks. The operation engine is not able to edit, change, add, remove, or decrypt any of the data in any of the data vaults. In some embodiments, the operation engine is configured to be a trusted actor for the operations because it is configured without any ability to threaten the security of the data in any of the data vaults beyond what is allowed in the policies.

The operation engine 302 performs the operation using the data from the data vaults and generates results 322 from the operation. The results are compiled to generate a compiled report 324. The compiled report is configured into a configured report 326. In some embodiments, the configured report expresses the results in terms of the data vault 312 that is owned or operated by the operator of the vault interface 375. As an example, in some embodiments, the report is configured by indicating requester values that meet the requested operations, e.g. by attaching flags to identified values of the first data vault that meet the identified operation in the request. The report may be configured in any other way that identifies the values of the first data vault that have a match in another data vault. The finally configured report is then sent 328 to the vault interface 375 through the service interface 304.

Accordingly, the operation engine 302 is able to take a transformed representation of the values in a field of the first data vault, compare it to a transformed representation of values in a related field of another data vault and then find matches, higher or lower values, common means, or some other operation. As an example, both data vaults may store a hash of the plain text value of the corresponding fields as an encryption scheme. If so, then a hash of a value from one data vault may be compared to a hash of a value from another data vault without any decryption being required. In some embodiments, the data vaults may store the relevant values using different encryption schemes and the operation engine is configured to perform the operation on the values when they are transformed in two different ways.

In one example operation, Company A and Company B both have data vaults that include many records that include PII. The records may correspond to accounts, services, product tests, fulfillments, patients, or any other type of record. Alternatively, instead of PII the records include trade secret information or both. Neither company wants to allow the other to view its records, at least not in an unrestricted form, however, both companies want to cooperate to improve their understanding of their own records. Both companies may also want to expand using the records of the other company, for example, if the companies are in complementary and not competing businesses. Company A and Company B may establish a joint policy for the exchange of information in their respective data vaults. Either company may then generate a request to perform operations on the other's data.

For a first example of a request, Company A may request to know if any of its customers are also customers of Company B. If Company A sells popcorn and Company B sells home video, then Company A would be able to market popcorn to those that are buying home video from Company B. The report may be configured to flag all records of Company A that correspond to customers of Company B. Company A has no access to customers of Company B that are not customers of Company A.

For a second example of a request, Company A may also request to know an indicator of the wealth of the common customers. Company B may have values for purchase amounts, credit scores, residential area, or other indicators of wealth. This information may be provided to Company A only for common customers. The escrow service may also reduce the detail in the information to a quantized score e.g., from 1 to 5, a hash, a truncated value, or another type of value. Company A would then be able to market a type of popcorn appropriate to the customer's taste or ability to pay.

Instead of matching to a particular identity on a record, the vault interface may instead ask for matches on particular combinations of criteria. Values from multiple fields may be used to generate a fingerprint of a particular type of record. If Company A produces a repair item and Company B performs repairs, then Company A may generate a request that would allow it to determine a trend in demand for the repair item. The request may identify the operation and a type of product, a repair time range, and repair price within a particular numerical range. Such a request may allow Company A to determine how many relevant repairs have been made during each time range and thereby to determine a trend. While Company B's data vault may contain extensive PII and trade secret business information, none of this information needs to be included in the report and Company A has not directly accessed any of Company B's data. Using multiple data vaults from multiple repair service companies, a still more accurate prediction of future demand may be made.

For a third example of a request, a researcher wants to know if the interaction between two drugs leads to more severe hospitalizations. In this example, the answer may be found by first finding all persons that have been prescribed with drug A and with drug B from a first one or two data vaults and that have had a hospital stay as recorded in a second data vault. A report with anonymized data may be sent to the requesting research for comparison to other drug combinations and control groups. In this example, it may be that the drug makers for drug A and drug B are willing to share dosage data with the researcher but only with anonymized data and only for the patients which have been prescribed with both drugs.

In this example the maker of drug A maintains a secure data vault with dosage information for patients that are taking drug A. The maker of drug B maintains a different secure data vault with dosage information for patients that are taking drug B. If the drug makers do not have common patient identifiers, then to determine which patients take both drug A and drug B, other information, which likely includes patient PII is used to match a patient. The escrow service can analyze this data from both data vaults without exposing it to the other drug maker or to any other party. For the third part of the request, a secure data vault maintained by a hospital is used to match the patients with hospital stays. Again, the patients may have wholly or partially different identifiers. The hospital may wish to keep its patient list secret.

The request may be performed, in one embodiment, by the escrow service, by computing a fingerprint that can be applied to the PII of drug makers' vaults to find matching persons. The escrow service then retrieves drug dosage data for each person that is in both vaults. The escrow service applies the fingerprint to the PII of the hospital to find persons in all three vaults and then retrieves information about those persons' hospital visits. The fingerprint does not need to be in the report to the researcher who gains no information about the patients' dosage habits nor about any patients that did not take both drug A and drug B.

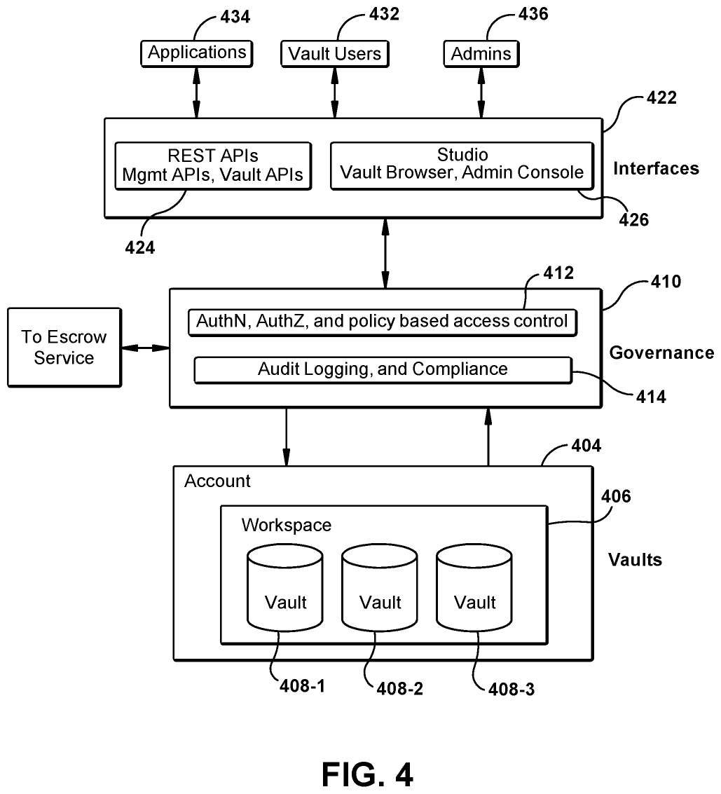

FIG. 4 is a block diagram of data vaults suitable for use with the escrow system and having possible access to the escrow system. The requester and partner data vaults may take different forms than that shown here and may also differ from each other. An account 404 includes a workspace 406 that includes one or more data vaults 408-1, 408-2, 408-3. The data vaults are secure and use sophisticated privacy technology to keep data secure and private. The vaults 408 may be isolated, highly distributed, and highly available to store sensitive data. The data may be encrypted at rest, in transit, and in-memory while being processed. This constant encryption dramatically improves the business security posture, as a significant number of data breaches happen on in-memory data. On top of strong encryption, the vaults 408 may incorporate several privacy-preserving technologies to protect sensitive data.

The data in a vault may be configured in any of a variety of different ways. In embodiments, a high-level schema is provided as a working template based on typical business needs. The template may include fields and relations in a database format. For example, a customer identity vault template may include the sensitive fields a business would typically want to collect about a customer (e.g., name, email, address, telephone number, billing account, organization, date of birth, etc.). An administrator may add or delete fields and populate the template with actual data.

In some embodiments, enterprise-grade governance tools 410 control access to the account and the vaults. The governance tools may include any of a variety of different policy-based access controls 412 and audit, logging, and compliance controls 414 to grant or deny access to data in the vaults 408. Data sets in a data vault may have corresponding audit logs that record all events. The logs may be aggregated and reported in analysis, audit, and metrics dashboards. The governance tools may also provide a Role-Based Access Control (RBAC) model in addition to a Policy-Based Access Control model. RBAC provides easy access control to stakeholders based on roles and privileges.

Users 432, applications 434, and administrators 436 obtain access to the governance tools through a direct interface 422, such as a browser interface and administrative console, or through APIs (Application Programming Interfaces) 424, such as REST (Representational State Transfer) APIs, management APIs, and vault APIs. The browser interface may be used to enable data exploration and account management with a simple graphical user interface. Clicking on various links, panes, windows, and dialog boxes may be configured to drive queries and other operations. The APIs allow applications and user interfaces to obtain access to the data vaults for a variety of user functions. The APIs may also be used for account and workspace management functions. The escrow service obtains access to the workspace 406 and to other workspaces (not shown) through the governance tools 410. The escrow service may use APIs and other tools to access the vaults. The governance tools 410 ensure that the escrow service only access the workspace as permitted by administrators of the workspace 406.

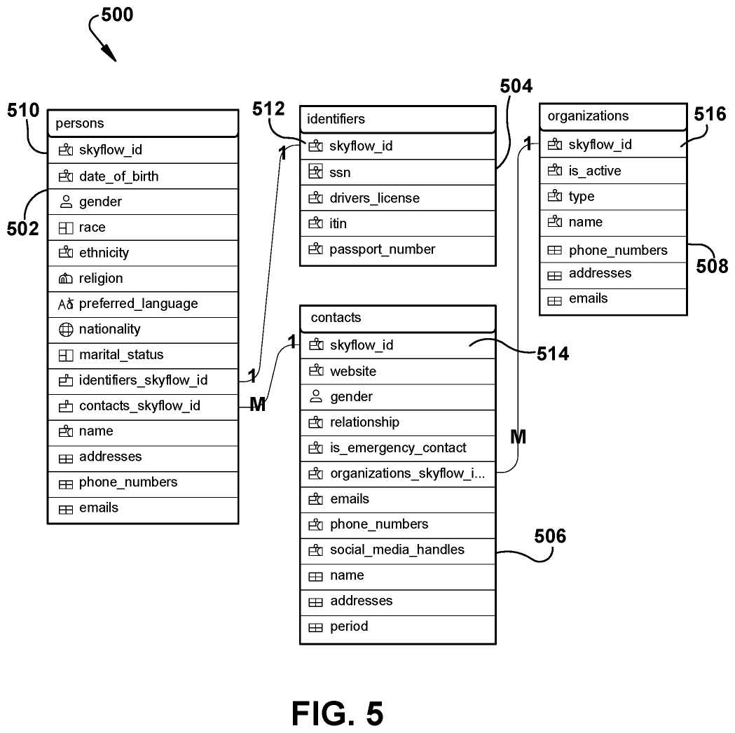

FIG. 5 is a diagram of a GUI (Graphical User Interface) for an example schema for a customer identity data vault. Such a GUI may be presented to a workplace administrator, vault creator, vault editor, or vault owner. The schema 500 is represented as a relational database with linked tables, but any other storage format may be used. The customer identity vault is an example of a structure for storing sensitive personal information. More or less information may be stored, depending on the needs of the users. The same or a similar structure may be used for other types of information. In this example, customer identity encompasses all the personal information related to an individual customer or user needed by the vault's users. Identity could include everything from demographic data such as gender and race, to contact information such as email and phone number, to key personal identifiers like SSN. The present schema 500 has four tables inside the customer identity vault, a persons table 502, an identifiers table 504, a contacts table 506, and an organizations table 508. The tables are illustrated with a single column showing a label for each row. The next column to the right which is not shown contains values for a particular customer. Each column is directed to a different customer, such that each column is a record for a customer and the row labels identify each of the fields for the record. Each table will have hundreds, thousands or more columns, there being one for each customer. The particular configuration of rows and columns may be modified to suit any different data sets and use scenarios.

The tables are all connected or related by an index field 510, 512, 514, 516 which is called skyflow_id in this example. The index field uniquely identifies a particular customer. Each field in the vault (e.g., skyflow_id, SSN, gender, etc.) may also have an associated privacy data type, as described in more detail below. A vault owner or workspace manager can insert data into the vault from an interface or API by entering the parameters that are to be changed. An interface may allow for a user to identify a table or object, a row, and a column, and then the new or different value that is to be written there. In some embodiments, the new values are indicated in a JSON (JavaScript Object Notation) format.

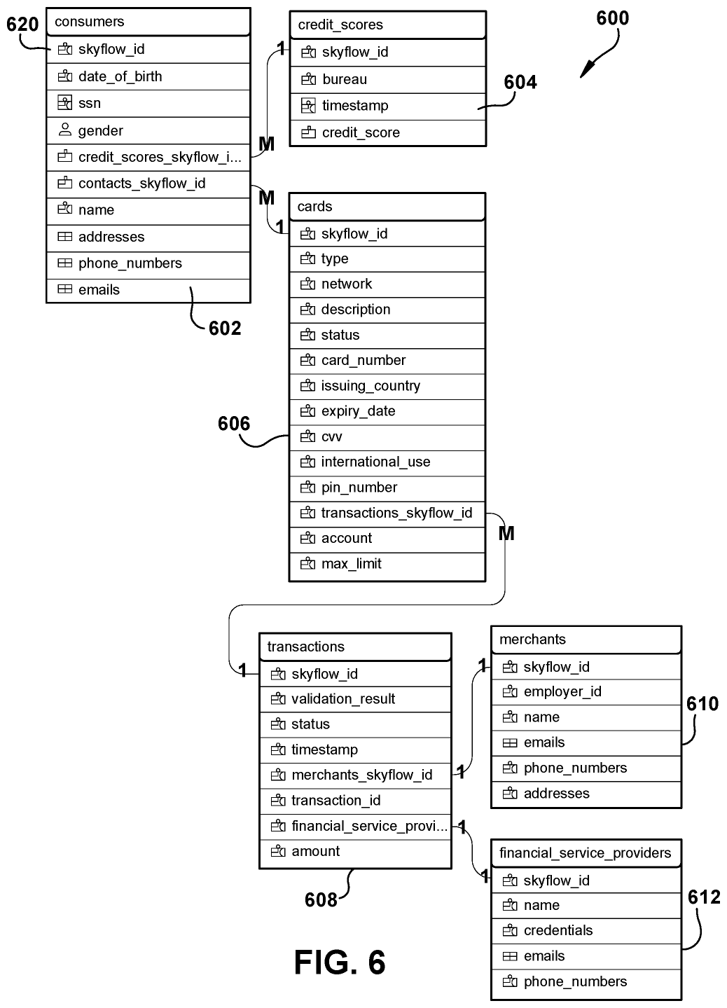

FIG. 6 is a diagram of a GUI for an example schema for a payments data vault. The payments schema 600 is also represented as a relational database with linked tables but any other storage format may be used. The payment vault structure 600 has six tables or objects, however, there may be more or fewer to suit different applications. In this example, there is a consumers table 602 for a profile of each consumer, including fields for information such as name, address, email etc. A credit scores table 604 includes consumer credit data fields such as credit scores and credit reports. A cards table 606 contains fields for card information including values for PAN (Primary Account Number), expiration date, issuing country etc. A transactions table 608 contains payment transaction-related data fields including merchant, amount, transaction validation result, etc. A merchants table 610 contains fields for merchant profiles. The type of merchant may be modified to suit a particular business. The merchants may be vendors, customers, partners, or other merchants. A financial service provider table 612 has fields for information about the financial service providers that are used by the company that owns the vault.

This example payments data vault 600 also uses an index field called skyflow_id 620 to relate all of the tables together. As with the customer identity vault, the illustrated tables represent the headers of two-dimensional tables that include a column for each object or record and a row for each attribute. Each field has a value for each object or record or for each unique skyflow_id. The values in the vault can only be modified by those with special access privileges. Indeed, any interaction with data in a vault may be restricted by particular privileges pertaining to the particular role with which a user or application attempts to access the data.

The payment vault may be designed to help companies reduce their PCI (Payment Card Industry) compliance scope and bring products to market faster. The vault may be used as a sensitive object store for sensitive financial data such as credit data, card issuance data and payment data. By storing sensitive financial data in the payment vault, a company can reduce the cost of maintaining security because that data will not be stored on company servers. As a result, the company can focus on product innovation and bringing products to market faster.

As with the customer identity vault or any other vault, the payment vault also enables businesses to execute secure vault functions within the security confines of the vault. These vault functions may be configured to enable businesses to make external API calls from directly within the vault. This reduces the need for any sensitive data regarding the API call to leave the vault and risk interception or capture. For example, an API call may be made directly from the vault to financial service providers. These calls may be used to support credit checks, card issuance and payment processing vault functions.

Some example uses of a payment vault include reducing the scope of a company's PCI Compliance by offloading sensitive data from the company's systems to the external vault using tokenization or other common design patterns. Another use is for credit score checks. A business can create a user profile and retrieve a consumer credit score from one or all of the three main credit bureaus: Experian; Equifax; and Transunion, among others. Another example is to use the vault for credit card issuance. A business may create a new card program with a partner and issue cards to its customers. Such a payment vault may also be used for payment processing in which the vault aids the company in obtaining the values needed to process a payment through partners. Any other vault may be configured by specifying all the tables and fields that are desired as well as their properties. Tables are added to the schema. Fields are added to each table and tags are attached to each field.

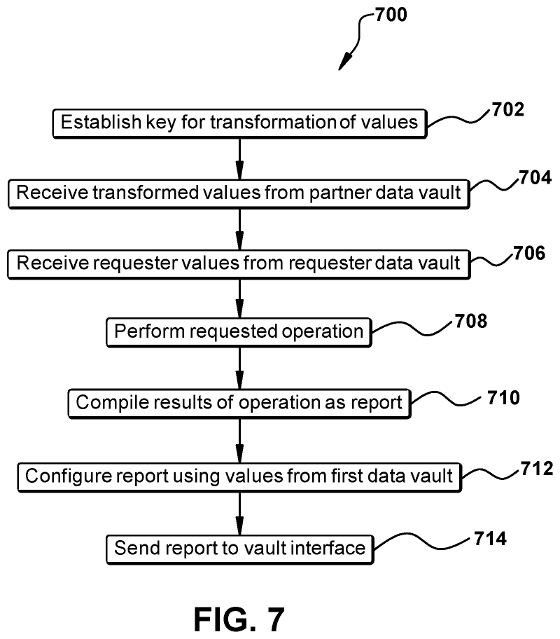

FIG. 7 is a process flow diagram of performing an operation on data vaults and reporting the result to a vault interface. A process begins with configuring policies that permit a vault interface to have restricted access to data from at least one data vault. The policies may be limited by time, type of data, particular fields, and any other suitable configuration. In the event that the vault interface seeks access to a vault that is owned or controlled by another, then there may be a negotiation to an agreement about the restrictions that are to be placed on the vault interface to access the other party's data. In some embodiments, the data vault transforms and sends only data that has been requested by the escrow service and that has been approved in the agreement.

An escrow service receives an operation request from a requester. The operation request identifies an operation that is to be performed by an operation engine of the escrow service. The operation request also identifies values of a first data vault, e.g., the requester data vault, and of a partner data vault with which to perform the identified operation. Considering a simple example, the request may identify all user names within a particular postal code of the requester data vault. Stated more specifically, the request may identify a postal code and define a search to retrieve all values in the user name field for which the postal code field of the same record has a particular value. For higher security, the user name field is not available and a record ID is used. The requester may then match the record ID to its own data.

Before acting on the request, an operation engine of the escrow service may check the request against any stored policies. The policies may determine whether the vault interface is permitted to request the operation and whether the operation is permitted to be performed on the requested second data vault. The policies may also determine which information from the second data vault, if any, may be provided back to the vault interface.

At 702, the escrow service establishes a key for the transformation of values from the partner data vault. In some embodiments, the escrow service generates a key for the transformation of values from a partner data vault and sends the key to the partner data vault. The escrow service may also send a key to the requester data vault, if the requester values are also to be transformed. The keys may be sent through a secure connection and the same secure connection may also be used for the transformed values. In another embodiment one of the vaults, a requester vault or a partner vault generates a key and sends it through a secure communication channel to the other vaults. In some embodiments, a cryptographic key agreement may be performed between one or more of the vaults and the escrow service to establish an encryption key. In some embodiments, the escrow service may also generate a key for the transformation of values from the requester data vault. The keys allow the values to be transformed into a format suitable for the requested operation. In some embodiments, the escrow service sends the key to the partner data vault.

At 704 the escrow service receives the identified values as transformed values from the partner data vault. These transformed values may be transformed using the key that was sent to the partner data vault. The requester data vault and the partner data vault have values in multiple different fields for multiple different objects or records. While some of the objects may be customers, other objects may represent other things or constructs. The data vaults may have any of a variety of different structures and schema. The received values may be stored in a local memory by a data interface to the respective data vault. In some embodiments, the vault interface which sends the request to the escrow service has access to the requester data vault and may also have privileges to edit or add to the requester data vault. The identified values in the requester data vault may be encrypted. Any PII or sensitive personal or business information may be encrypted.

At 706 the escrow service receives values from the requester. These may be transformed values from the requester data vault that are transformed using the key that was sent to the requester data vault. The corresponding values may also be stored locally in a memory associated with the data interface to the second data vault. These values may also be encrypted. The second data vault may be identified by the vault interface in the request, identified in the policies, or indicated in another way.

At 708 the operation engine of the escrow service performs the requested operation identified in the request using the identified values from the first data vault and the corresponding values from the second data vault. With these values stored locally, the operation engine may readily access the data and perform the operation. In the above example, a join operation of user names in the second data vault may be performed by applying the list of user names with the corresponding postal code from the first data vault to the user names in the second data vault. For each matching name a result may be declared and stored in the results memory of the operation engine.

In some embodiments, the identified values in the first data vault are encrypted and the corresponding values in the second data vault are also encrypted. The identified operation may be performed using the values in transformed form. If the values are transformed in the same way, then a match may be performed on the transformed values. If the values are transformed in different ways, then the identified values from the first data vault may be converted from an encryption scheme of the first data vault to an encryption scheme of the corresponding values of the second data vault before performing the identified operation. Alternatively, the corresponding values from the second data vault may be converted from an encryption scheme of the second data vault to an encryption scheme of the corresponding values of the first data vault before performing the identified operation. Depending on the nature of the encryption, there may also be an operation that may be performed on the identified values and an operation that may be performed on the corresponding values that allow the values to be compared for the operation in a common transformed form.

At 710 the results of the operation are compiled as a report by the operation engine for the vault interface. The results may be stored in a results memory. At 712 the report is configured using the identified values from the first data vault. In the example above, rather than send a list of users from the second data vault, the operation engine may flag the users from the first data vault which have a match in the second data vault. This is a way that configuring the report comprises attaching flags to identified values that meet the identified operation. Stated another way, configuring the report comprises preparing a list of the identified values which have a match in the corresponding values. In some embodiments, the configured report indicates requester values by sending back the requester values that meet the operation, e.g., have a match. At 714 the configured report is sent to the vault interface through the service interface.

Using this process, the vault interface receives a report but does not access either the first data vault or the second data vault. In embodiments, the escrow service does not decrypt any of the values in either data vault or decrypts only some of the values. The escrow service controls access to the data vaults by the vault interface and prevents any data from coming to the vault interface except that which is permitted in the policies.

In one example, a requester vault has names that are associated with zip codes. The partner vault also has names associated with zip codes. Both vaults also have record identifiers that are implicitly or explicitly specified in the structure or the schema of the records in the associated vault. In other words, some or all of the records each have a name field, a zip code field, and an index field or a field that can be used as an index for the respective record. The requester value zip codes and the partner vault zip codes are transformed using e.g., a one-way key transformation both using the same key and the transformed data is sent from both vaults to the escrow service. The escrow service performs a match and tells the requester which records matched. The match information may identify each match using an index field, a record id, or the transformed zip code; depending on the use-case. The requester uses the report internally at the requester's data vault to find the corresponding records for which there was a match, i.e., the usernames that are also present, as shown by the match operation, in the partner data vault. In this way, the escrow service requires only the data needed to perform the requested operation. Neither the requester nor the partner has access to any of the other party's data. The operations of the escrow service keep the information secure when matching is done.

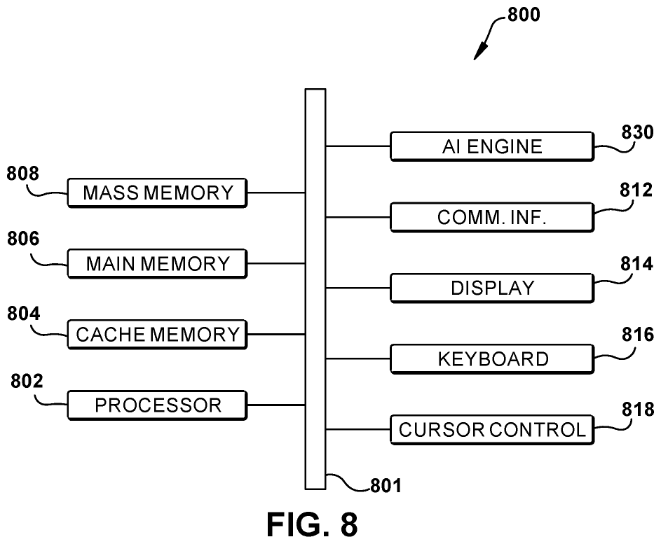

FIG. 8 is a block diagram of a computer system 800 representing an example of a system upon which features of the described embodiments may be implemented, such as the user devices, interfaces, governance, workspace, escrow service, and data vaults. In the case of cloud services, one or more of the components may be virtualized. The computer system includes a bus or other communication means 801 for communicating information, and a processing means such as one or more microprocessors 802 coupled with the bus for processing information. The computer system further includes a cache memory 804, such as a random-access memory (RAM) or other dynamic data storage device, coupled to the bus for storing information and instructions to be executed by the processor. The main memory also may be used for storing temporary variables or other intermediate information during execution of instructions by the processor. The computer system may also include a main nonvolatile memory 806, such as a read only memory (ROM) or other static data storage device coupled to the bus for storing static information and instructions for the processor.

A mass memory 808 such as a solid-state disk, magnetic disk, disk array, or optical disc and its corresponding drive may also be coupled to the bus of the computer system for storing information and instructions. The computer system can also be coupled via the bus to a display device or monitor 814 for displaying information to a user. For example, graphical and textual indications of installation status, operations status, schema configurations, and other information may be presented to the user on the display device. Typically, an alphanumeric input device 816, such as a keyboard with alphanumeric, function and other keys, may be coupled to the bus for communicating information and command selections to the processor. A cursor control input device 818, such as a mouse, a trackball, trackpad, or cursor direction keys can be coupled to the bus for communicating direction information and command selections to the processor and to control cursor movement on the display.

A communication device 812 is also coupled to the bus. The communication device may include a wired or wireless modem, a network interface card, or other well-known interface devices, such as those used for coupling to Ethernet, token ring, cellular telephony, Wi-Fi, or other types of physical attachment for purposes of providing a communication link to support a local or wide area network (LAN or WAN), for example. In this manner, the computer system may also be coupled to a number of clients or servers via one or more conventional network infrastructures, including an Intranet or the Internet, for example.

The system of FIG. 8 further includes an AI (Artificial Intelligence) engine. This may be implemented in dedicated hardware using parallel processing or in the processor 802 or using some combination of resources. The AI engine may also be external to the computer system 800 and connected through a network node or some other means. The AI engine may be configured to use historical data accumulated by the computer system or another system to build a model that includes weights and criteria to apply to the selection processes, operations, and encryption among others. The model may be repeatedly rebuilt using the accumulated data to refine and increase accuracy.

A lesser or more equipped computer system than the example described above may be preferred for certain implementations. Therefore, the configuration of the exemplary computer system will vary from implementation to implementation depending upon numerous factors, such as price constraints, performance requirements, technological improvements, or other circumstances. The computer system may be duplicated in different locations for distributed computing. As an example, the system may use a simple pre-programmed deterministic selection model instead of an AI model and the AI engine.

While the steps described herein may be performed under the control of a programmed processor, in alternative embodiments, the steps may be fully or partially implemented by any programmable or hard coded logic, such as Field Programmable Gate Arrays (FPGAs), TTL logic, or Application Specific Integrated Circuits (ASICs), for example. Additionally, the methods described herein may be performed by any combination of programmed general purpose computer components or custom hardware components. Therefore, nothing disclosed herein should be construed as limiting the present invention to a particular embodiment wherein the recited steps are performed by a specific combination of hardware components.

In the present description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. The specific detail may be supplied by one of average skill in the art as appropriate for any particular implementation.

The present description includes various steps, which may be performed by hardware components or may be embodied in machine-readable instructions, such as software or firmware instructions. The machine-readable instructions may be used to cause a general-purpose or special-purpose processor programmed with the instructions to perform the steps. Alternatively, the steps may be performed by a combination of hardware and software.

The described operations may be provided as a computer program product that may include a machine-readable medium having stored instructions thereon, which may be used to program a computer (or other machine) to perform a process according to the present invention. The machine-readable medium may include, but is not limited to optical disks, CD-ROMs, and magneto-optical disks, ROMs, RAMs, EPROMs, EEPROMs, magnet or optical cards, flash memory, or any other type of medium suitable for storing electronic instructions. Moreover, the present invention may also be downloaded as a computer program product, wherein the program may be transferred from a remote computer to a requesting computer by way of data signals embodied in a carrier wave or other machine-readable propagation medium via a communication link (e.g., a modem or network connection).

Some embodiments described herein pertain to a non-transitory machine-readable medium comprising a plurality of instructions, executed on a computing device, to facilitate the computing device to perform one or more of any of the operations described in the various embodiments herein.

Secure reporting operations are described that are suitable with multiple data vaults. An escrow service facilitates such reporting operation with a requester data interface to receive a request to perform an operation and to receive requester values from a requester data vault. The operation request identifies the operation and fields of the requester data vault with which to perform the identified operation. A data interface receives transformed values from a partner data vault, the values being transformed using a key. An operation engine establishes the key for the transformation of values from the partner data vault, to perform an operation on the transformed values and the requester values, to compile results of the operation as a report, and to configure the report using the requester values, wherein the requester interface is further to send the report to the requester.

In some embodiments, the operation engine configures the report by attaching flags to identified requested values that meet the identified operation. In some embodiments, the identified values include values for a field of the requester data vault that are within an identified numerical range.

Another embodiment may be expressed as a method that includes sending an operation request to an escrow service, the operation request identifying the operation and fields of a partner data vault with which to perform the identified operation, establishing a key for the transformation of values from a requester data vault, transforming values from the requester data vault using the key, sending the transformed values to the escrow service, and receiving a report from the escrow service showing results of the requested operation.

In some embodiments, establishing a key comprises receiving a key through a secure tunnel from the escrow service that was generated by the escrow service. In some embodiments, transforming values comprises transforming values by a keyed one-way transformation.

Some embodiments include canonicalizing the transformed values before sending the transformed values to the escrow service.

Another embodiment may be expressed as a method that includes establishing a key for the transformation of values from a partner data vault, receiving transformed values from the partner data vault, the values being transformed using the key, receiving requester values from a requester data vault, performing an operation on the transformed values and the requester values, compiling results of the operation as a report, configuring the report using the requester values, and sending the report to the requester.

Some embodiments include receiving an operation request from the requester, the operation request identifying the operation and fields of the requester data vault with which to perform the identified operation. Some embodiments include generating a requester key for the transformation of values from the requester data vault, and receiving transformed requester values from the requester data vault, the transformed requester values being transformed using the requester key, wherein performing an operation comprises performing the operation on the transformed values and the requester transformed values.

In some embodiments, establishing a key comprises generating a key to transform encrypted values of the partner data vault to a form suitable for performing the operation.

Some embodiments include forming a session with the partner data vault, and wherein sending the key and receiving transformed values is performed within the escrow session.

In some embodiments, the transformed values are transformed by a keyed one-way transformation.

Some embodiments include canonicalizing the transformed values and the requester values, and wherein performing an operation comprises matching.

In some embodiments, performing an operation comprises performing a join operation and wherein configuring the report comprises indicating requester values that match a corresponding transformed value. In some embodiments, the transformed values are encrypted and wherein performing the operation comprises performing the operation without decrypting the transformed values.

In some embodiments, configuring the report comprises attaching flags to identified requested values that meet the identified operation. In some embodiments, the identified requester values include values for multiple records in a single field of the requester data vault. In some embodiments, the identified values include values for a field of the requester data vault that are within an identified numerical range. In some embodiments, the identified values include values for multiple records of the requester data vault in multiple fields and wherein performing an operation includes performing combinations of values in different fields.

Although this disclosure describes some embodiments in detail, it is to be understood that the invention is not limited to the precise embodiments described. The specification and drawings are, accordingly, to be regarded in an illustrative rather than a restrictive sense. Various adaptations, modifications and alterations may be practiced within the scope of the invention defined by the appended claims.

What is claimed is:

1. A method comprising:
establishing a key for the transformation of values from a partner data vault;
receiving transformed values from the partner data vault, the values being transformed using the key;
receiving requester values from a requester data vault;
performing an operation on the transformed values and the requester values;
compiling results of the operation as a report;
configuring the report using the requester values; and
sending the report to the requester.

2. The method of claim 1, further comprising receiving an operation request from the requester, the operation request identifying the operation and fields of the requester data vault with which to perform the identified operation.

3. The method of claim 1, further comprising:
generating a requester key for the transformation of values from the requester data vault; and
receiving transformed requester values from the requester data vault, the transformed requester values being transformed using the requester key,
wherein performing an operation comprises performing the operation on the transformed values and the requester transformed values.

4. The method of claim 1, wherein establishing a key comprises generating a key to transform encrypted values of the partner data vault to a form suitable for performing the operation.

5. The method of claim 4, further comprising forming a session with the partner data vault, and wherein sending the key and receiving transformed values is performed within the escrow session.

6. The method of claim 1, wherein the transformed values are transformed by a keyed one-way transformation.

7. The method of claim 1, further comprising canonicalizing the transformed values and the requester values, and wherein performing an operation comprises matching.

8. The method of claim 1, wherein performing an operation comprises performing a join operation and wherein configuring the report comprises indicating requester values that match a corresponding transformed value.

9. The method of claim 1, wherein the transformed values are encrypted and wherein performing the operation comprises performing the operation without decrypting the transformed values.

10. The method of claim 1, wherein configuring the report comprises attaching flags to identified requested values that meet the identified operation.

11. The method of claim 10, wherein the identified requester values include values for multiple records in a single field of the requester data vault.

12. The method of claim 10, wherein the identified values include values for a field of the requester data vault that are within an identified numerical range.

13. The method of claim 10, wherein the identified values include values for multiple records of the requester data vault in multiple fields and wherein performing an operation includes performing combinations of values in different fields.

14. An escrow service comprising:
a requester data interface to receive a request to perform an operation, the operation request identifying the operation and fields of the requester data vault with which to perform the identified operation, and to receive requester values from a requester data vault;
a data interface to receive transformed values from a partner data vault, the values being transformed using a key; and
an operation engine to establish the key for the transformation of values from the partner data vault, to perform an operation on the transformed values and the requester values, to compile results of the operation as a report, and to configure the report using the requester values,
wherein the requester interface is further to send the report to the requester.

15. The escrow service of claim 14, wherein the operation engine configures the report by attaching flags to identified requested values that meet the identified operation.

16. The escrow service of claim 15, wherein the identified values include values for a field of the requester data vault that are within an identified numerical range.

17. A method comprising:
sending an operation request to an escrow service, the operation request identifying the operation and fields of a partner data vault with which to perform the identified operation;
establishing a key for the transformation of values from a requester data vault;
transforming values from the requester data vault using the key;
sending the transformed values to the escrow service; and
receiving a report from the escrow service showing results of the requested operation.

18. The method of claim 17, wherein establishing a key comprises receiving a key through a secure tunnel from the escrow service that was generated by the escrow service.

19. The method of claim 17, wherein transforming values comprises transforming values by a keyed one-way transformation.

20. The method of claim 17, further comprising canonicalizing the transformed values before sending the transformed values to the escrow service.
